(19) United States
(12) Patent Application Publication
(10) Pub. No.: US 2020/0413440 A1
(43) Pub. Date: Dec. 31, 2020

(54) AUTOMATIC DETECTION OF A PATTERN OF DYNAMIC TRANSMISSION BOUNDARIES

(71) Applicant: QUALCOMM Incorporated, San Diego, CA (US)

(72) Inventors: Alessio Marcone, Nuremberg (DE); Marco Papaleo, Bologna (IT)

(21) Appl. No.: 16/889,435

(22) Filed: Jun. 1, 2020

Related U.S. Application Data
(60) Provisional application No. 62/868,584, filed on Jun. 28, 2019.

(51) Int. Cl. H04W 74/04; H04L 5/02; H04L 5/22; H04W 16/14; H04W 56/00; H04B 17/327

(52) U.S. Cl. CPC H04W 74/04; H04L 5/023; H04B 17/327; H04W 16/14; H04W 56/001; H04L 5/22

(57) ABSTRACT

In a particular implementation, a method of wireless communication includes detecting, at a first user equipment (UE) corresponding to a first protocol, one or more time slots during which a second UE corresponding to a second protocol is transmitting via a wireless channel. The first protocol is different than the second protocol. The method also includes transmitting, by the first UE, a message via the wireless channel during at least one time slot and according to a pattern based on the detected one or more time slots. The pattern indicates a set of time slots designated as unavailable based on use by one or more UEs corresponding to the second protocol.

### CROSS-REFERENCE TO RELATED APPLICATIONS

This application claims the benefit of U.S. Provisional Patent Application No. 62/868,584, entitled, “AUTOMATIC DETECTION OF A PATTERN OF DYNAMIC TRANSMISSION BOUNDARIES,” filed on Jun. 28, 2019, which is expressly incorporated by reference herein in its entirety as if fully set forth below and for all applicable purposes.

### TECHNICAL FIELD

Aspects of the present disclosure relate generally to wireless communication systems, and more particularly, by way of example but not limitation, to detecting transmission boundaries.

### INTRODUCTION

Wireless communication networks are widely deployed to provide various communication services such as voice, video, packet data, messaging, broadcast, and the like. These wireless networks may be multiple-access networks capable of supporting multiple users by sharing the available network resources. Such networks, which are usually multiple access networks, support communications for multiple users by sharing the available network resources.

A wireless communication network may include a number of base stations or node Bs that can support communication for a number of user equipments (UEs). A UE may communicate with a base station via downlink and uplink. The downlink (or forward link) refers to the communication link from the base station to the UE, and the uplink (or reverse link) refers to the communication link from the UE to the base station.

A base station may transmit data and control information on the downlink to a UE and/or may receive data and control information on the uplink from the UE. On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the neighbor base stations or from other wireless RF transmitters. This interference may degrade performance on both the downlink and uplink.

As the demand for mobile broadband access continues to increase, the possibilities of interference and congested networks grows with more UEs accessing the long-range wireless communication networks and more short-range wireless systems being deployed in communities. Research and development continue to advance wireless technologies not only to meet the growing demand for mobile broadband access, but to advance and enhance the user experience with mobile communications.

### BRIEF SUMMARY OF SOME EMBODIMENTS

The following summarizes some aspects of the present disclosure to provide a basic understanding of the discussed technology. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In one aspect of the disclosure, a method for wireless communication includes detecting, at a first user equipment (UE) corresponding to a first protocol, one or more time slots during which a second UE corresponding to a second protocol is transmitting via a wireless channel. The first protocol can be different from the second protocol. The method includes transmitting, by the first UE, a message via the wireless channel during at least one time slot according to a pattern based on the detected one or more time slots. The pattern represents a set of time slots designated as unavailable based on use by one or more UEs corresponding to the second protocol.

In an additional aspect of the disclosure, an apparatus configured for wireless communication includes at least one processor and a memory coupled to the at least one processor. The memory stores instructions that, when executed by the at least one processor, cause the at least one processor to detect, at a first user equipment (UE) corresponding to a first wireless communication technology, one or more time slots during which a second UE corresponding to a second wireless communication technology is transmitting via a wireless channel. The first wireless communication technology can be different from the second wireless communication technology. The instructions, when executed by the at least one processor, further cause the at least one processor to initiate transmission of a message via the wireless channel during at least one time slot according to a pattern based on the detected one or more time slots. The pattern represents a set of time slots designated as unavailable based on use by one or more UEs corresponding to the second wireless communication technology.

In an additional aspect of the disclosure, an apparatus for wireless communication includes means for detecting, at a first user equipment (UE) corresponding to a first protocol, one or more time slots during which a second UE corresponding to a second protocol is transmitting via a wireless channel. The first protocol is different than the second protocol. The apparatus further includes means for transmitting a message via the wireless channel during at least one time slot according to a pattern based on the detected one or more time slots. The pattern represents a set of time slots designated as unavailable based on use by one or more UEs corresponding to the second protocol.

In an additional aspect of the disclosure, a non-transitory computer-readable medium stores instructions that, when executed by a processor, cause the processor to perform operations including detecting, at a first user equipment (UE) corresponding to a first wireless communication technology, one or more time slots during which a second UE corresponding to a second wireless communication technology is transmitting via a wireless channel. The first wireless communication technology can be different from the second wireless communication technology. The operations further include initiating transmission of a message via the wireless channel during at least one time slot according to a pattern based on the detected one or more time slots. The pattern represents a set of time slots designated as unavailable based on use by one or more UEs corresponding to the second wireless communication technology.

Other aspects, features, and embodiments will become apparent to those of ordinary skill in the art, upon reviewing the following description of specific, exemplary embodiments in conjunction with the accompanying figures. While features of the present invention may be discussed relative to certain embodiments and figures below, all embodiments can include one or more of the advantageous features discussed herein. In other words, while one or more embodiments may be discussed as having certain advantageous features, one or more of such features may also be used in accordance with the various embodiments discussed herein. In similar fashion, while exemplary embodiments may be discussed below as device, system, or method embodiments the exemplary embodiments can be implemented in various devices, systems, and methods.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating details of a wireless communication system according to some embodiments of the present disclosure.

FIG. 2 is a block diagram conceptually illustrating a design of a base station and a UE configured according to some embodiments of the present disclosure.

FIG. 3 is a block diagram illustrating an example of a wireless communication system that includes a UE that determines a transmission pattern in accordance with aspects of the present disclosure.

FIG. 4 is a diagram that illustrates various superframes divided between two protocols in accordance with aspects of the present disclosure.

FIG. 5 is a diagram of time slots divided between two protocols and determining a pattern of time slots in accordance with aspects of the present disclosure.

FIG. 6 is a diagram of signal detections used to determine a pattern of time slot assignments to multiple protocols.

FIG. 7 is a block diagram illustrating example blocks executed by a UE configured according to an aspect of the present disclosure.

FIG. 8 is a block diagram conceptually illustrating a design of a UE configured to determine a transmission pattern according to some aspects of the present disclosure.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

Intelligent transportation systems (ITS) applications enable vehicles to communicate with other vehicles or with roadside infrastructure. One protocol for ITS communications is ITS-G5, which is based on the Institute of Electrical and Electronics Engineers (IEEE) 802.11p standard. Another protocol for ITS communications is a long-term evolution (LTE)-V2X protocol. In some geographic regions, government regulations may enable both ITS-G5 communications and LTE-V2X communications to operate in the same communications band (e.g., the 5.9 gigahertz (GHz) band). Thus, coexistence between ITS-G5 communications and LTE-V2X communications is an issue.

One proposal for dealing with this issue is to have ITS-G5 UEs (e.g., UEs operating in accordance with the ITS-G5 protocol) monitor a wireless channel for LTE-V2X communications and, if one is detected, back off for a designated time period T1. However, the LTE-V2X communications may not take an entirety of the designated time period T1, leading to inefficiency in use of the wireless channel. A second proposal for dealing with this issue is to have a LTE-V2X UE (e.g., a UE operating in accordance with the LTE-V2X protocol) estimate the channel occupancy of LTE-V2X compared to the total channel occupancy and assign sub-frames (e.g., time slots) within a frame to LTE-V2X communications, with the remainder of the sub-frames assigned to ITS-G5 communications. To avoid ITS-G5 transmissions starting in the last empty symbol of a LTE-V2X sub-frame, the LTE-V2X UE is required to send a header with an ITS-G5 preamble that indicates a 1 millisecond (ms) reservation. However, because the ITS-G5 UEs are unaware of this scheduling, an ITS-G5 UE may transmit during a gap between LTE-V2X transmissions, thereby creating interference on the wireless channel. Additionally, requiring the LTE-V2X UE to send an ITS-G5 preamble prevents the LTE-V2X station from using those bits for other purposes, such as Tx/Rx switching and propagation delays.

The systems, methods, devices, and apparatuses described herein enable a user equipment (UE) operating in accordance with a first protocol (e.g., an ITS-G5 protocol) to monitor a wireless channel, detect transmissions by a second UE operating in accordance with a second protocol (e.g., a LTE-V2X protocol), and to determine a pattern of time slot assignments to communications in accordance with the first protocol and communications in accordance with the second protocol. Once the UE determines the pattern, the UE may transmit a message during one or more time slots in accordance with the pattern (e.g., during one or more time slots designated for communications according to the first protocol). In this manner, UEs operating in accordance with the first protocol will not interfere with UEs operating in accordance with the second protocol, which enables coexistence between the two types of UEs on a single wireless channel.

This disclosure relates generally to providing or participating in communication as between two or more wireless devices in one or more wireless communications systems, also referred to as wireless communications networks. In various embodiments, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5th Generation (5G) or new radio (NR) networks (sometimes referred to as “5G NR” networks/systems/devices), as well as other communications networks. As described herein, the terms “networks” and “systems” may be used interchangeably.

A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may, for example implement a radio technology such as GSM. 3GPP defines standards for the GSM EDGE (enhanced data rates for GSM evolution) radio access network (RAN), also denoted as GERAN. GERAN is the radio component of GSM/EDGE, together with the network that joins the base stations (for example, the Ater and Abis interfaces) and the base station controllers (A interfaces, etc.). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may comprise one or more GERANs, which may be coupled with Universal Terrestrial Radio Access Networks (UTRANs) in the case of a UMTS/GSM network. An operator network may also include one or more LTE networks, and/or one or more other networks. The various different network types may use different radio access technologies (RATs) and radio access networks (RANs).

An OFDMA network may implement a radio technology such as evolved UTRA (E-UTRA), IEEE 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3rd Generation Partnership Project (3GPP) is a collaboration between groups of telecommunications associations that aims to define a globally applicable third generation (3G) mobile phone specification. 3GPP long term evolution (LTE) is a 3GPP project aimed at improving the universal mobile telecommunications system (UMTS) mobile phone standard. The 3GPP may define specifications for the next generation of mobile networks, mobile systems, and mobile devices. For clarity, certain aspects of the apparatus and techniques may be described below for LTE implementations or in an LTE-centric way, and LTE terminology may be used as illustrative examples in portions of the description below; however, the description is not intended to be limited to LTE applications. Indeed, the present disclosure is concerned with shared access to wireless spectrum between networks using different radio access technologies or radio air interfaces.

A new carrier type based on LTE/LTE-A including unlicensed spectrum has also been suggested that can be compatible with carrier-grade WiFi, making LTE/LTE-A with unlicensed spectrum an alternative to WiFi. LTE/LTE-A, when operating in unlicensed spectrum, may leverage LTE concepts and may introduce some modifications to physical layer (PHY) and media access control (MAC) aspects of the network or network devices to provide efficient operation in the unlicensed spectrum and meet regulatory requirements. The unlicensed spectrum used may range from as low as several hundred Megahertz (MHz) to as high as tens of Gigahertz (GHz), for example. In operation, such LTE/LTE-A networks may operate with any combination of licensed or unlicensed spectrum depending on loading and availability. Accordingly, it may be apparent to one of skill in the art that the systems, apparatus and methods described herein may be applied to other communications systems and applications.

System designs may support various time-frequency reference signals for the downlink and uplink to facilitate beamforming and other functions. A reference signal is a signal generated based on known data and may also be referred to as a pilot, preamble, training signal, sounding signal, and the like. A reference signal may be used by a receiver for various purposes such as channel estimation, coherent demodulation, channel quality measurement, signal strength measurement, and the like. MIMO systems using multiple antennas generally provide for coordination of sending of reference signals between antennas; however, LTE systems do not in general provide for coordination of sending of reference signals from multiple base stations or eNBs.

In some implementations, a system may utilize time division duplexing (TDD). For TDD, the downlink and uplink share the same frequency spectrum or channel, and downlink and uplink transmissions are sent on the same frequency spectrum. The downlink channel response may thus be correlated with the uplink channel response. Reciprocity may allow a downlink channel to be estimated based on transmissions sent via the uplink. These uplink transmissions may be reference signals or uplink control channels (which may be used as reference symbols after demodulation). The uplink transmissions may allow for estimation of a space-selective channel via multiple antennas.

In LTE implementations, orthogonal frequency division multiplexing (OFDM) is used for the downlink—that is, from a base station, access point or eNodeB (eNB) to a user terminal or UE. Use of OFDM meets the LTE requirement for spectrum flexibility and enables cost-efficient solutions for very wide carriers with high peak rates, and is a well-established technology. For example, OFDM is used in standards such as IEEE 802.11a/g, 802.16, High Performance Radio LAN-2 (HIPERLAN-2, wherein LAN stands for Local Area Network) standardized by the European Telecommunications Standards Institute (ETSI), Digital Video Broadcasting (DVB) published by the Joint Technical Committee of ETSI, and other standards.

Time frequency physical resource blocks (also denoted here in as resource blocks or “RBs” for brevity) may be defined in OFDM systems as groups of transport carriers (e.g. sub-carriers) or intervals that are assigned to transport data. The RBs are defined over a time and frequency period. Resource blocks are comprised of time-frequency resource elements (also denoted here in as resource elements or “REs” for brevity), which may be defined by indices of time and frequency in a slot. Additional details of LTE RBs and REs are described in the 3GPP specifications, such as, for example, 3GPP TS 36.211.

UMTS LTE supports scalable carrier bandwidths from 20 MHz down to 1.4 MHZ. In LTE, an RB is defined as 12 sub-carriers when the subcarrier bandwidth is 15 kHz, or 24 sub-carriers when the sub-carrier bandwidth is 7.5 kHz. In an exemplary implementation, in the time domain there is a defined radio frame that is 10 ms long and consists of 10 subframes of 1 millisecond (ms) each. Every subframe consists of 2 slots, where each slot is 0.5 ms. The subcarrier spacing in the frequency domain in this case is 15 kHz. Twelve of these subcarriers together (per slot) constitute an RB, so in this implementation one resource block is 180 kHz. Six Resource blocks fit in a carrier of 1.4 MHz and 100 resource blocks fit in a carrier of 20 MHz.

Moreover, it should be understood that, in operation, wireless communication networks adapted according to the concepts herein may operate with any combination of licensed or unlicensed spectrum depending on loading and availability. Accordingly, it will be apparent to one of skill in the art that the systems, apparatus and methods described herein may be applied to other communications systems and applications than the particular examples provided.

While aspects and embodiments are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, embodiments and/or uses may come about via integrated chip embodiments and/or other non-module-component based devices (e.g., end-user devices, vehicles, communication devices, computing devices, industrial equipment, retail/purchasing devices, medical devices, AI-enabled devices, etc.). While some examples may or may not be specifically directed to use cases or applications, a wide assortment of applicability of described innovations may occur. Implementations may range from chip-level or modular components to non-modular, non-chip-level implementations and further to aggregated, distributed, or OEM devices or systems incorporating one or more described aspects. In some practical settings, devices incorporating described aspects and features may also necessarily include additional components and features for implementation and practice of claimed and described embodiments. It is intended that innovations described herein may be practiced in a wide variety of implementations, including both large/small devices, chip-level components, multi-component systems (e.g. RF-chain, communication interface, processor), distributed arrangements, end-user devices, etc. of varying sizes, shapes, and constitution.

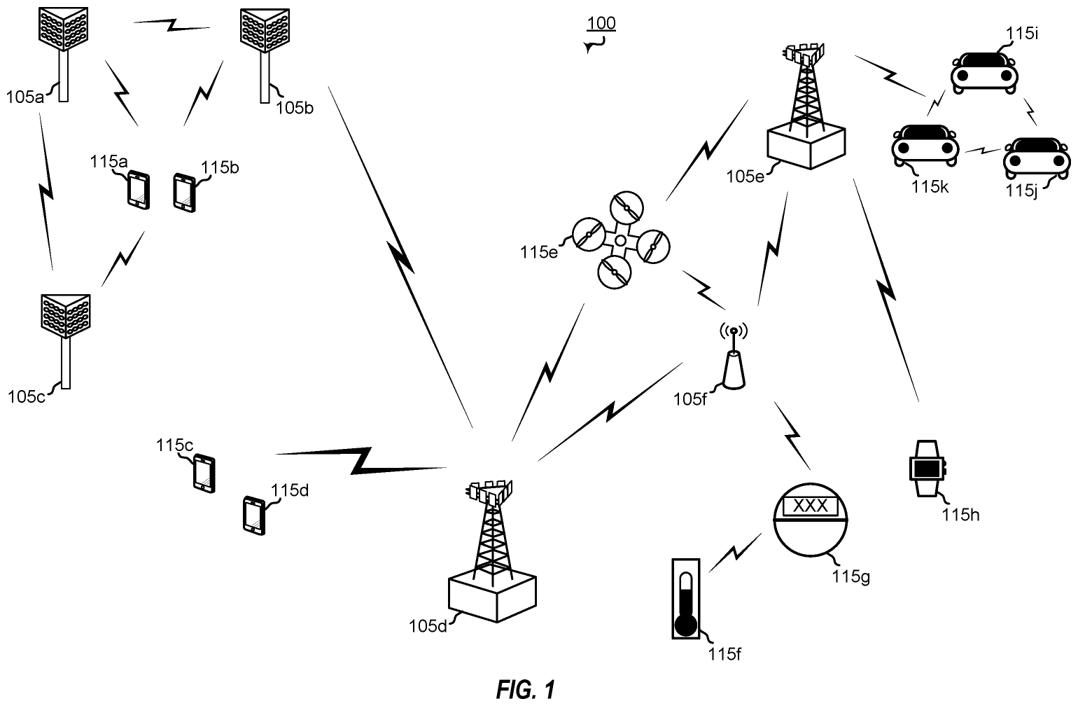

FIG. 1 shows wireless network 100 for communication according to some embodiments. Wireless network 100 may, for example, comprise a 5G wireless network. As appreciated by those skilled in the art, components appearing in FIG. 1 are likely to have related counterparts in other network arrangements including, for example, cellular-style network arrangements and non-cellular-style-network arrangements (e.g., device to device or peer to peer or ad hoc network arrangements, etc.).

Wireless network 100 illustrated in FIG. 1 includes a number of base stations 105 and other network entities. A base station may be a station that communicates with the UEs and may also be referred to as an evolved node B (eNB), a next generation eNB (gNB), an access point, and the like. Each base station 105 may provide communication coverage for a particular geographic area. In 3GPP, the term “cell” can refer to this particular geographic coverage area of a base station and/or a base station subsystem serving the coverage area, depending on the context in which the term is used. In implementations of wireless network 100 herein, base stations 105 may be associated with a same operator or different operators (e.g., wireless network 100 may comprise a plurality of operator wireless networks), and may provide wireless communications using one or more of the same frequencies (e.g., one or more frequency bands in licensed spectrum, unlicensed spectrum, or a combination thereof) as a neighboring cell. In some examples, an individual base station 105 or UE 115 may be operated by more than one network operating entity. In other examples, each base station 105 and UE 115 may be operated by a single network operating entity.

A base station may provide communication coverage for a macro cell or a small cell, such as a pico cell or a femto cell, and/or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 1, base stations 105d and 105e are regular macro base stations, while base stations 105a-105c are macro base stations enabled with one of 3 dimension (3D), full dimension (FD), or massive MIMO. Base stations 105a-105c take advantage of their higher dimension MIMO capabilities to exploit 3D beamforming in both elevation and azimuth beamforming to increase coverage and capacity. Base station 105f is a small cell base station which may be a home node or portable access point. A base station may support one or multiple (e.g., two, three, four, and the like) cells.

Wireless network 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 115 are dispersed throughout the wireless network 100, and each UE may be stationary or mobile. It should be appreciated that, although a mobile apparatus is commonly referred to as user equipment (UE) in standards and specifications promulgated by the 3rd Generation Partnership Project (3GPP), such apparatus may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. Within the present document, a “mobile” apparatus or UE need not necessarily have a capability to move, and may be stationary. Some non-limiting examples of a mobile apparatus, such as may comprise embodiments of one or more of UEs 115, include a mobile, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A mobile apparatus may additionally be an “Internet of things” (IoT) or “Internet of everything” (IoE) device such as an automotive or other transportation vehicle, a satellite radio, a global positioning system (GPS) device, a logistics controller, a drone, a multi-copter, a quad-copter, a smart energy or security device, a solar panel or solar array, municipal lighting, water, or other infrastructure; industrial automation and enterprise devices; consumer and wearable devices, such as eyewear, a wearable camera, a smart watch, a health or fitness tracker, a mammal implantable device, gesture tracking device, medical device, a digital audio player (e.g., MP3 player), a camera, a game console, etc.; and digital home or smart home devices such as a home audio, video, and multimedia device, an appliance, a sensor, a vending machine, intelligent lighting, a home security system, a smart meter, etc. In a particular implementation, a UE may be a vehicle (or a component thereof). In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 115a-115d of the embodiment illustrated in FIG. 1 are examples of mobile smart phone-type devices accessing wireless network 100 A UE may also be a machine specifically configured for connected communication, including machine type communication (MTC), enhanced MTC (eMTC), narrowband IoT (NB-IoT) and the like. UEs 115e-115k illustrated in FIG. 1 are examples of various machines configured for communication that access wireless network 100.

A mobile apparatus, such as UEs 115, may be able to communicate with any type of the base stations, whether macro base stations, pico base stations, femto base stations, relays, and the like. In FIG. 1, a lightning bolt (e.g., communication link) indicates wireless transmissions between a UE and a serving base station, which is a base station designated to serve the UE on the downlink and/or uplink, or desired transmission between base stations, and backhaul transmissions between base stations. Backhaul communication between base stations of wireless network 100 may occur using wired and/or wireless communication links.

In operation at wireless network 100, base stations 105a-105c serve UEs 115a and 115b using 3D beamforming and coordinated spatial techniques, such as coordinated multipoint (CoMP) or multi-connectivity. Macro base station 105d performs backhaul communications with base stations 105a-105c, as well as small cell, base station 105f. Macro base station 105d also transmits multicast services which are subscribed to and received by UEs 115c and 115d. Such multicast services may include mobile television or stream video, or may include other services for providing community information, such as weather emergencies or alerts, such as Amber alerts or gray alerts.

Wireless network 100 of embodiments supports mission critical communications with ultra-reliable and redundant links for mission critical devices, such UE 115e, which is a drone. Redundant communication links with UE 115e include from macro base stations 105d and 105e, as well as small cell base station 105f. Other machine type devices, such as UE 115f (thermometer), UE 115g (smart meter), and UE 115h (wearable device) may communicate through wireless network 100 either directly with base stations, such as small cell base station 105f, and macro base station 105e, or in multi-hop configurations by communicating with another user device which relays its information to the network, such as UE 115f communicating temperature measurement information to the smart meter, UE 115g, which is then reported to the network through small cell base station 105f. Wireless network 100 may also provide additional network efficiency through dynamic, low-latency TDD/FDD communications, such as in a vehicle-to-vehicle (V2V) mesh network between UEs 115i-115k communicating with macro base station 105e.

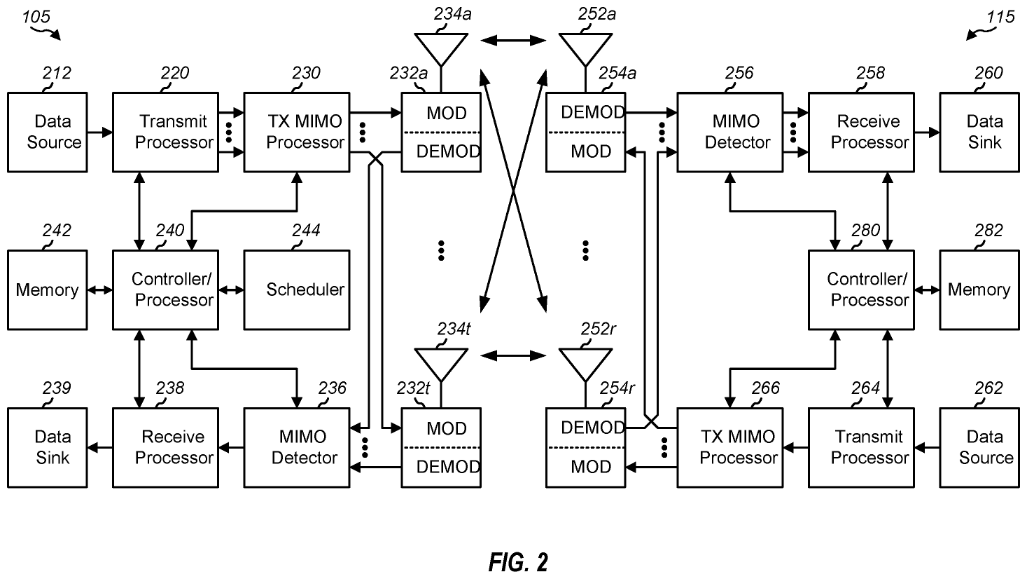

FIG. 2 shows a block diagram of a design of a base station 105 and a UE 115, which may be any of the base stations and one of the UEs in FIG. 1. For a restricted association scenario (as mentioned above), base station 105 may be small cell base station 105f in FIG. 1, and UE 115 may be UE 115c or 115D operating in a service area of base station 105f, which in order to access small cell base station 105f, would be included in a list of accessible UEs for small cell base station 105f. Base station 105 may also be a base station of some other type. As shown in FIG. 2, base station 105 may be equipped with antennas 234a through 234t, and UE 115 may be equipped with antennas 252a through 252r for facilitating wireless communications.

At the base station 105, a transmit processor 220 may receive data from a data source 212 and control information from a controller/processor 240. The control information may be for the physical broadcast channel (PBCH), physical control format indicator channel (PCFICH), physical hybrid-ARQ (automatic repeat request) indicator channel (PHICH), physical downlink control channel (PDCCH), enhanced physical downlink control channel (EPDCCH), MTC physical downlink control channel (MPDCCH), etc. The data may be for the PDSCH, etc. The transmit processor 220 may process (e.g., encode and symbol map) the data and control information to obtain data symbols and control symbols, respectively. The transmit processor 220 may also generate reference symbols, e.g., for the primary synchronization signal (PSS) and secondary synchronization signal (SSS), and cell-specific reference signal. Transmit (TX) multiple-input multiple-output (MIMO) processor 230 may perform spatial processing (e.g., precoding) on the data symbols, the control symbols, and/or the reference symbols, if applicable, and may provide output symbol streams to modulators (MODs) 232a through 232t. Each modulator 232 may process a respective output symbol stream (e.g., for OFDM, etc.) to obtain an output sample stream. Each modulator 232 may additionally or alternatively process (e.g., convert to analog, amplify, filter, and upconvert) the output sample stream to obtain a downlink signal. Downlink signals from modulators 232a through 232t may be transmitted via the antennas 234a through 234t, respectively.

At the UE 115, the antennas 252a through 252r may receive the downlink signals from the base station 105 and may provide received signals to the demodulators (DEMODs) 254a through 254r, respectively. Each demodulator 254 may condition (e.g., filter, amplify, downconvert, and digitize) a respective received signal to obtain input samples. Each demodulator 254 may further process the input samples (e.g., for OFDM, etc.) to obtain received symbols. MIMO detector 256 may obtain received symbols from demodulators 254a through 254r, perform MIMO detection on the received symbols if applicable, and provide detected symbols. Receive processor 258 may process (e.g., demodulate, deinterleave, and decode) the detected symbols, provide decoded data for the UE 115 to a data sink 260, and provide decoded control information to a controller/processor 280.

On the uplink, at the UE 115, a transmit processor 264 may receive and process data (e.g., for the physical uplink shared channel (PUSCH)) from a data source 262 and control information (e.g., for the physical uplink control channel (PUCCH)) from the controller/processor 280. Transmit processor 264 may also generate reference symbols for a reference signal. The symbols from the transmit processor 264 may be precoded by TX MIMO processor 266 if applicable, further processed by the modulators 254a through 254r (e.g., for SC-FDM, etc.), and transmitted to the base station 105. At base station 105, the uplink signals from UE 115 may be received by antennas 234, processed by demodulators 232, detected by MIMO detector 236 if applicable, and further processed by receive processor 238 to obtain decoded data and control information sent by UE 115. Receive processor 238 may provide the decoded data to data sink 239 and the decoded control information to controller/processor 240.

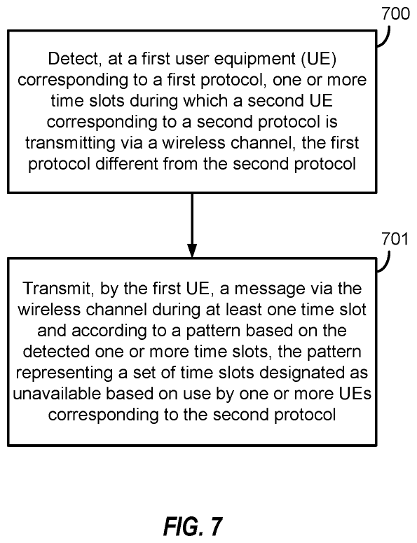

Controllers/processors 240 and 280 may direct the operation at base station 105 and UE 115, respectively. Controller/processor 240 and/or other processors and modules at base station 105 and/or controller/processor 28 and/or other processors and modules at UE 115 may perform or direct the execution of various processes for the techniques described herein, such as to perform or direct the execution illustrated in FIG. 7, and/or other processes for the techniques described herein. Memories 242 and 282 may store data and program codes for base station 105 and UE 115, respectively. Scheduler 244 may schedule UEs for data transmission on the downlink and/or uplink.

Wireless communications systems operated by different network operating entities (e.g., network operators) may share spectrum. In some instances, a network operating entity may be configured to use an entirety of a designated shared spectrum for at least a period of time before another network operating entity uses the entirety of the designated shared spectrum for a different period of time. Thus, in order to allow network operating entities use of the full designated shared spectrum, and in order to mitigate interfering communications between the different network operating entities, certain resources (e.g., time) may be partitioned and allocated to the different network operating entities for certain types of communication.

For example, a network operating entity may be allocated certain time resources reserved for exclusive communication by the network operating entity using the entirety of the shared spectrum. The network operating entity may also be allocated other time resources where the entity is given priority over other network operating entities to communicate using the shared spectrum. These time resources, prioritized for use by the network operating entity, may be utilized by other network operating entities on an opportunistic basis if the prioritized network operating entity does not utilize the resources. Additional time resources may be allocated for any network operator to use on an opportunistic basis.

Access to the shared spectrum and the arbitration of time resources among different network operating entities may be centrally controlled by a separate entity, autonomously determined by a predefined arbitration scheme, or dynamically determined based on interactions between wireless nodes of the network operators.

In some cases, UE 115 and base station 105 may operate in a shared radio frequency spectrum band, which may include licensed or unlicensed (e.g., contention-based) frequency spectrum. In an unlicensed frequency portion of the shared radio frequency spectrum band, UEs 115 or base stations 105 may traditionally perform a medium-sensing procedure to contend for access to the frequency spectrum. For example, UE 115 or base station 105 may perform a listen before talk (LBT) procedure such as a clear channel assessment (CCA) prior to communicating in order to determine whether the shared channel is available. A CCA may include an energy detection procedure to determine whether there are any other active transmissions. For example, a device may infer that a change in a received signal strength indicator (RSSI) of a power meter indicates that a channel is occupied. Specifically, signal power that is concentrated in a certain bandwidth and exceeds a predetermined noise floor may indicate another wireless transmitter. A CCA also may include detection of specific sequences that indicate use of the channel. For example, another device may transmit a specific preamble prior to transmitting a data sequence. In some cases, an LBT procedure may include a wireless node adjusting its own backoff window based on the amount of energy detected on a channel and/or the acknowledge/negative-acknowledge (ACK/NACK) feedback for its own transmitted packets as a proxy for collisions.

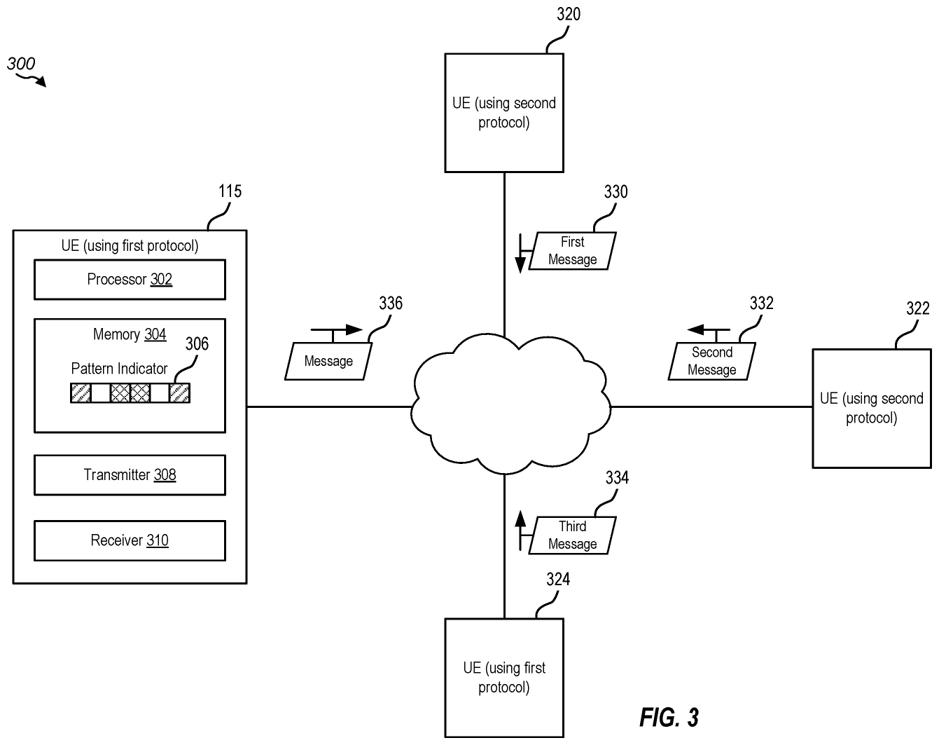

FIG. 3 illustrates an example of a wireless communications system 300 that includes a UE that determines a transmission pattern, as further described herein. In some examples, wireless communications system 300 may implement aspects of wireless network 100. For example, wireless communications system 300 includes UE 115. In addition, wireless communications system 300 includes a second UE 320, a third UE 322, and a fourth UE 324. In a particular implementation, UEs 115 and 320-324 may include or correspond to a vehicle, or a component thereof. For example, UE 115 may include or correspond to a component of a first vehicle, second UE 320 may include or correspond to a component of a second vehicle, third UE 322 may include or correspond to a component of a third vehicle, and fourth UE 324 may include or correspond to a component of a fourth vehicle. In other implementations, UEs 115 and 320-324 may be other devices.

UE 115 includes processor 302, memory 304, transmitter 308, and receiver 310. Processor 302 may be configured to execute instructions stored at memory 304 to perform the operations described herein. In some implementations, processor 302 includes or corresponds to controller/processor 280, and memory 304 includes or corresponds to memory 282. Memory 304 may also be configured to store a pattern indicator 306. Pattern indicator 306 may represent a pattern of time slot assignments (e.g., designations), as further described herein.

Transmitter 308 is configured to transmit data to one or more other devices, and receiver 310 is configured to receive data from one or more other devices. For example, transmitter 308 may transmit data, and receiver 310 may receive data, via a network, such as a wired network, a wireless network, or a combination thereof. For example, UE 115 may be configured to transmit and/or receive data via a direct device-to-device connection, a local area network (LAN), a wide area network (WAN), a modem-to-modem connection, the Internet, intranet, extranet, cable transmission system, cellular communication network, any combination of the above, or any other communications network now known or later developed within which permits two or more electronic devices to communicate. In some implementations, transmitter 308 and receiver 310 may be replaced with a transceiver. Additionally, or alternatively, transmitter 308, receiver, 310, or both may include or correspond to one or more components of UE 115 described with reference to FIG. 2. Although not illustrated for clarity, UEs 320-324 may also include a corresponding processor, memory, transmitter, and receiver (or transceiver).

In a particular implementation, UEs 115 and 320-324 may correspond to different protocols (e.g., different wireless communication technologies). As used herein, a UE corresponds to a particular protocol (e.g., wireless communication technology) if the UE operates in accordance with the particular protocol. In a particular implementation, UE 115 and fourth UE 324 correspond to a first protocol (e.g., a first wireless communication technology) and second UE 320 and third UE 322 correspond to a second protocol (e.g., a second wireless communication technology). For example, UEs 115 and 324 may operate in accordance with a first protocol, and UEs 320 and 322 may operate in accordance with a second protocol.

In a particular implementation, the first protocol and the second protocol correspond to the same communication band. In some such implementations, the communication band is the 5.9 gigahertz (GHz) band. In some such implementations, the first protocol (e.g., the first wireless communication technology) is an ITS-G5 protocol, and the second protocol (e.g., the second wireless communication technology) is a LTE-V2X protocol. For example, UEs 115 and 324 may operate in accordance with the ITS-G5 protocol, UEs 320 and 322 may operate in accordance with the LTE-V2X protocol, and UEs 115 and 320-324 may share a wireless channel that corresponds to the 5.9 GHz band. In other implementations, the first protocol and the second protocol are different protocols, the wireless channel corresponds to a different communication band (or channel), or both.

During operation of wireless communications system 300, UE 115 monitors a wireless channel shared by UEs 115 and 320-324. For example, before transmitting, UE 115 (e.g., processor 302) may be configured to monitor the wireless channel for a time period to detect one or more time slots in order to determine a pattern of time slot assignments (e.g., to communications in accordance with the first protocol or with the second protocol). UE 115 monitors the wireless channel and detects one or more time slots during which a UE corresponding to the second protocol (e.g., UEs 320 and 322) is transmitting via the wireless channel. In some implementations, UE 115 may detect transmission by a single UE, such as broadcast transmissions (e.g., by second UE 320 or third UE 322). In other implementations, UE 115 may detect transmissions between one or more UEs, such as UEs 320 and 322. UE 115 transmits a message 336 via the wireless channel during at least one time slot and according to a pattern based on the detected one or more time slots. The pattern corresponds to a set of time slots designated as unavailable based on detected communication with respect to the second protocol. For example, the pattern represents a set of time slots designated as unavailable based on use by one or more UEs (e.g., UEs 320 and 322) corresponding to the second protocol. In some implementations, the pattern further represents a second set of time slots designated as available for UEs corresponding to the first protocol.

To illustrate, UE 115 (e.g., processor 302 and receiver 310) may monitor the wireless channel for one or more messages during one or more time slots. The messages may include a first message 330 transmitted by second UE 320, a second message 332 transmitted by third UE 322, and a third message 334 transmitted by fourth UE 324. UE 115 may detect messages (or the energy corresponding to messages) and detect the time slots during which the messages occur to determine a pattern of time slot assignment. Detection of a message corresponding to the second protocol means a corresponding time slot is designated for communications in accordance with the second protocol, and detection of a message corresponding to the first protocol or an availability of the wireless channel means a corresponding time slot is designated for communications in accordance with the first protocol. For example, if third message 334 is transmitted during a first time slot, no message is transmitted during a second time slot, first message 330 is transmitted during a third time slot, second message 332 is transmitted during a fourth time slot, no message is transmitted during a fifth time slot, and another message is transmitted by fourth UE 324 during a sixth time slot, UE 115 may determine a pattern based on those six time slots. To illustrate, UE 115 may determine that the third time slot and the fourth time slot are unavailable due to use by UEs 320 and 322, which correspond to (e.g., operate in accordance with) the second protocol. Additionally, UE 115 may determine that the first time slot, the second time slot, the fifth time slot, and the sixth time slot are available for transmission by UEs corresponding to (e.g., operating in accordance with) the first protocol, because those time slots were either available (e.g., empty of transmissions) or used for transmissions by UEs that correspond to the first protocol.

UE 115 may generate and store pattern indicator 306 at memory 304. Pattern indicator 306 represents the pattern determined by UE 115. For example, based on the above-described example, pattern indicator 306 indicates that the first time slot and the sixth time slot are designated for communications by UEs operating in accordance with the first protocol (as indicated by the particular shading in the first and sixth boxes). Pattern indicator 306 also indicates that time slots 2 and 5 are available, and thus designated for communications by UEs operating in accordance with the first protocol (as indicated by the lack of shading in the second and fifth boxes). Pattern indicator 306 also indicates that time slots 3 and 4 are designated for communications by UEs operating in accordance with the second protocol (as indicated by the particular shading in the third and fourth boxes).

In a particular implementation, pattern indicator 306 is a bitmap that represents the pattern. For example, each bit of the bitmap may have a first value if the corresponding time slot is designated for communications in accordance with the first protocol, and a second value if the corresponding time slot is designated for communications in accordance with the second protocol. In another particular implementation, pattern indicator 306 is a coded value that represents the pattern. For example, pattern indicator 306 may be a binary or hexadecimal number that represents the pattern, similar to a bitmap. In other implementations, pattern indicator 306 may be another type of indicator.

UE 115 may generate pattern indicator 306 by detecting the pattern based on received messages. In a particular implementation, UE 115 may only be able to identify messages from other UEs operating in accordance with the first protocol. For example, UE 115 may identify third message 334 as a message by identifying a particular preamble (in accordance with the first protocol) in third message 334. For example, messages in accordance with the first protocol may include the particular preamble before data portions of the messages. In this implementation, UE 115 may be able to detect that a message is being transmitted in accordance with the second protocol by detecting an amount of energy on the wireless channel that satisfies a threshold without detecting a particular preamble. For example, if UE 115 detects an amount of energy on the wireless channel that satisfies a threshold, but is unable to detect the particular preamble, UE 115 may determine that a message is being transmitted in accordance with the second protocol. Additionally, or alternatively, if UE 115 detects an amount of energy that fails to satisfy a second threshold (e.g., one that is less than the threshold), UE 115 may determine that a message is being transmitted in accordance with the second protocol.

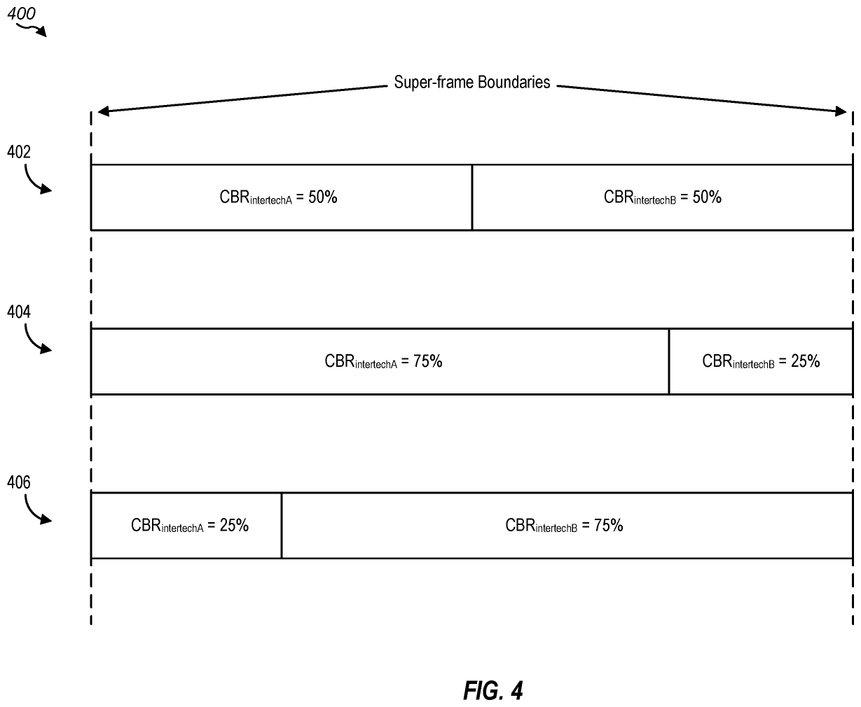

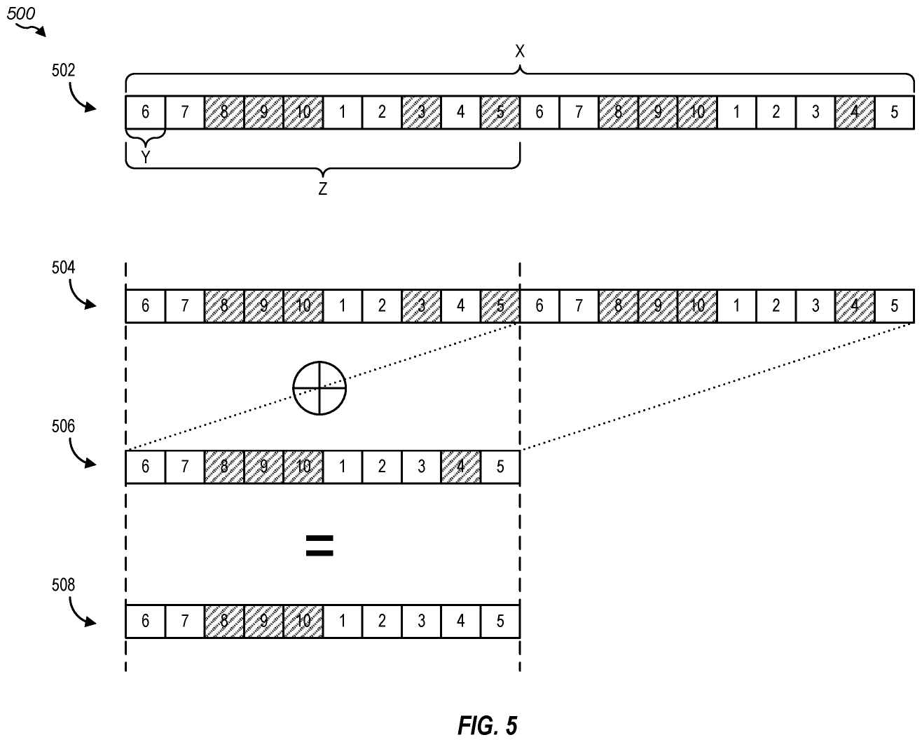

In a particular implementation, UE 115 (e.g., processor 302 and receiver 310) monitors the wireless channel for a longer time period than a time period associated with the pattern. For example, in the above example illustrated in FIG. 3, the pattern included 6 time slots. Each time slot may correspond to 1 millisecond (ms), and thus the pattern may correspond to 6 ms. In this implementation, before transmitting for the first time, UE 115 may monitor the channel for 30 ms, breaking each monitoring session into a 6 ms monitoring session. UE 115 may compare the various 6 ms monitoring sessions to determine which time slots are designated for transmission by which protocols. For example, UE 115 (e.g., processor 302) may detect transmissions that occur during 6 consecutive time slots (e.g., a first sub-time period) and detect transmissions that occur during the next 6 consecutive time slots (e.g., a second sub-time period). UE 115 (e.g., processor 302) may determine which slots used by one or more UEs operating in accordance with the second protocol overlap (e.g., are the same in both monitored sub-time periods). The overlapping time periods are used to define the pattern, as further described with reference to FIG. 5. Although the pattern is described as having a duration of 6 ms and the monitoring period is described as having a duration of 30 ms, such examples are for illustration only. In other implementations, the pattern may have a duration of 10 ms (e.g., 10 time slots of 1 ms each), and the monitoring time may be 100 ms, as further described with reference to FIGS. 4 and 5, or the durations may be other values.

In some implementations, the pattern is cyclical over the time period (e.g., the pattern repeats itself every sub-time period). For example, in the example above, the pattern repeats itself every six time slots. Thus, a UE that monitors the wireless channel for more than the sub-time period (e.g., 6 ms, as a non-limiting example) such that the UE can determine the pattern even if during one sub-time period another UE transmits out of turn. In such situation, the out-of-turn transmission will not overlap with other transmissions of the same type, so the UE will not incorrectly determine the pattern. In some implementations, the particular time period corresponds to a duration of a superframe that is repeated after expiration of the particular time period. For example, a superframe having a duration (e.g., 6 ms) may be divided between time slots corresponding to the first protocol and time slots corresponding to the second protocol. Examples of superframes are further described with reference to FIG. 4. The duration of the superframe may be preprogrammed at the UE (e.g., known by the UE a-priori) or received by the UE from one or more other devices, such as a base station or another UE, as non-limiting examples.

In a particular implementation, the set of time slots designated for communications according to the second protocol (e.g., designated as unavailable to the UEs operating in accordance to the first protocol) are adjacent time slots within a time period. For example, in the example of FIG. 3, the third time slot and the fourth time slot are designated for communications in accordance with the second protocol, which are adjacent time slots. In this manner, UEs corresponding to the first protocol will not interfere with transmissions from UEs corresponding to the second protocol, because the UEs corresponding to the first protocol are not associated with time slots until after a block of time slots corresponding to the second protocol.

In a particular implementation, one or more UEs that correspond to (e.g., operate in accordance with) the second protocol establish the pattern. For example, the pattern may be established by second UE 320 or third UE 322. The one or more UEs may establish the pattern based on a metric based on a channel busy ratio (CBR). To illustrate, one or more of the UEs corresponding to the second protocol may determine CBR values and determine a metric based on the CBR values, and the metric may be used to assign the time slots to either communications in accordance with the first protocol or communications in accordance with the second protocol. Additional details describing determination of the metric, and assignment of the time slots, is further described with reference to FIG. 4. Thus, UEs corresponding to the second protocol establish the schedule, and UEs corresponding to the first protocol determine the schedule by monitoring the wireless channel.

Thus, because UEs corresponding to the second protocol establish the pattern, and UEs corresponding to the first protocol detect the pattern, the wireless communications system 300 implements a time division multiplexing (TDM) system across multiple wireless communication technologies (e.g., the first protocol and the second protocol). The TDM system (or a TDM scheme used by the TDM system) may define a time partition between the first protocol and the second protocol. The time partition may be static, semi-static, or dynamic. For example, if the time partition is static, time partitions between communications in accordance with the first protocol and communications in accordance with the second protocol may all have a same fixed duration. Such static partitioning may be indicated by a wireless communications standard. As another example, if the time partition is dynamic, durations of time partitions between communications in accordance with the first protocol and communications in accordance with the second protocol may be different. For example, a time partition associated with a particular protocol may be based on a measure of the relative channel occupancy associated with the particular protocol. Using dynamic time partitions may utilize resources more fairly that using static partitions, but may also increase complexity. As another example, if the time partition is semi-static, an external device may measure the channel occupancy associated with the various protocols and instruct the UEs to follow certain time partitions. Using semi-static time partitions may be less complex than using dynamic time partitions, while achieving at least some of the fairness benefits. Additionally, use of the dynamic or semi-static time partitions may enable changing time partition durations when a UE, such as a vehicle, moves into a different environment with different channel occupancies associated with the various protocols.

The TDM system is implemented without the UEs being synchronized with respect to each other. For example, UEs corresponding to the first protocol (e.g., UE 115 and fourth UE 324) are not synchronized with respect to UEs corresponding to the second protocol (e.g., second UE 320 and third UE 322) and may not have accurate absolute time synchronization. For example, clock signals generated by UEs corresponding to the first protocol may diverge in time from an absolute clock signal (e.g., Coordinated Universal Time (UTC) time) by as much as 1 ms. In some implementations, the timing accuracy of the UEs corresponding to the first protocol may be lower than the timing accuracy of the UEs corresponding to the second protocol. For example, in a particular implementation, the timing accuracy of the UEs corresponding to the first protocol is 1 ms, and the timing accuracy of the UEs corresponding to the second protocol is less than 1 ms. The lack of synchronization between UEs corresponding to the different protocols is not problematic, because the UEs corresponding to the first protocol determine the pattern on their own, instead of receiving the pattern from the UEs corresponding to the second protocol (which may create timing issues due to the lack of synchronization).

After determining the pattern (and storing pattern indicator 306), UE 115 (e.g., transmitter 308) transmits message 336 during at least one time slot and according to the pattern. For example, transmitter 308 may transmit message 336 to one or more other devices (or broadcast the message) via the wireless channel during at least one time slot that is designated for communications in accordance with the first protocol. To further illustrate, based on the example above, following the time period of monitoring the wireless channel, message 336 may be transmitted during a first time slot, a second time slot, a fifth time slot, and/or a sixth time slot. Message 336 may be transmitted after a time period of monitoring the wireless channel. For example, UE 115 may be configured to monitor the wireless channel for a time period (and to determine the pattern) before transmitting any messages.

In a particular implementation, a method of wireless communication (e.g., a method of operation of UE 115) includes detecting, at a first user equipment (e.g., 115) corresponding to a first protocol, one or more time slots (e.g., the third and fourth time slots) during which a second UE (e.g., 320) corresponding to a second protocol is transmitting via a wireless channel. The first protocol is different than the second protocol. The method also includes transmitting, by the first UE, a message (e.g., 336) via the wireless channel during at least one time slot and according to a pattern based on the detected one or more time slots. The pattern represents a set of time slots designated as unavailable based on use by one or more UEs (e.g., 320, 322) corresponding to the second protocol.

Thus, FIG. 3 describes a UE (e.g., 115) that corresponds to a first protocol (e.g., ITS-G5) to monitor a wireless channel for a particular time period and to determine a pattern (as represented by pattern indicator 306) of assignments of time slots to the different protocols. In this manner, UEs corresponding to the second protocol (e.g., LTE-V2X) may establish a pattern of transmission assignments, and UEs corresponding to the first protocol may monitor the wireless channel and determine the pattern. Thus, even though the various UEs are not synchronized in time, and UEs corresponding to the first protocol are asynchronous and may have a timing accuracy on the order of 1 ms, UEs corresponding to two different types of protocols, such as ITS-G5 and LTE-V2X, may coexist on one wireless channel without causing interference to each other. Advantageously, dynamic coexistence between two different protocols on the same wireless channel may be achieved. Additionally, UEs corresponding to the second protocol do not have to transmit preambles according to the first protocol, which preserves the bits for other uses, such as Tx/Rx switching and propagation delays.

FIG. 4 illustrates a diagram 400 of various superframes divided between two protocols. The pattern described in FIG. 3 may correspond to a superframe. For example, a superframe of Z ms may be defined, for example in a wireless communication standard. UEs corresponding to the first protocol and UEs corresponding to the second protocol may be programmed with the length of the superframe. Alternatively, the duration of the superframe may be signaled to the UEs, such as by a base station or by other UEs. In a particular implementation, the superframe has a duration of 10 ms. Thus, 10 time slots of 1 ms each make up the superframe. In other implementation, the superframe has other durations.

The superframe may be divided into time slots that correspond to the first protocol (e.g., a first wireless communication technology) also referred to as “intertechB” and time slots that correspond to the second protocol (e.g., a second wireless communication technology) also referred to as “intertechA.” The division of the superframe is based on CBR values, as further described herein.

FIG. 4 illustrates three illustrative superframes. In first superframe 402, CBR_{intertechA} is 50% and CBR_{intertechB} is 50%, so the superframe is divided into 5 time slots assigned to the first protocol and 5 time slots assigned to the second protocol. In second superframe 404, CBR_{intertechA} is 75% and CBR_{intertechB} is 25%, so the superframe is divided into 7 time slots assigned to the second protocol and 3 time slots assigned to the first protocol. In third superframe 406, CBR_{intertechA} is 25% and CBR_{intertechB} is 75%, so the superframe is divided into 3 time slots assigned to the second protocol and 7 time slots assigned to the first protocol. It is to be noted that in some implementations, the time slots designated for the second protocol are earlier in the superframe than the time slots designated for the first protocol. Additionally, the time slots designated for the second protocol are adjacent time slots and make up a block of time slots. Time slots designated for the first protocol are not interspersed with time slots designated for the second protocol. The superframe may be repeated after each superframe. For example, with respect to first superframe 402, the first 5 time slots are designated for the second protocol, the next 5 time slots are designated for the first protocol, the next 5 time slots are designated for the second protocol, the next 5 time slots are designated for the first protocol, etc.

In a particular implementation, the division of the superframe (e.g., the assignment of the time slots) is based on a metric based on CBR values. This division is determined by UEs corresponding to the second protocol. To illustrate, the metric may be referred to as Tech_{percentage} and may be given by the following equation, with respect to the first protocol being ITS-G5 and the second protocol being LTE-V2X:

Tech_{percentage}=(CBR_{LTE})/(CBR_{LTE+ITSG5})

where CBR_{LTE} is given by the following equation:

CBR_{LTE}=N_{PSCCHCRCPASS}/(numSubchannel*numSubframes_{Techpercentage})

where N_{PSCCHCRCPASS} is the number of LTE-V2X PSCCH decoded successfully (having a CRC pass) in the wireless channel during the last numSubframes_{Techpercentage}, whose retransmission flag indicates “0” (that is initial transmission). numSubchannel is the number of subchannels as defined in the standard, and numSubframes_{Techpercentage} is the integration time of the measurement, in some implementations set to 100 ms. CBR_{LTE+ITSG5} is one of two options: option 1—the CBR as defined in LTE-V2X, or option 2—CBR_{LTE}+CBR_{ITSG5}, where CBR_{ITSG5} measures the occupancy of the wireless channel originating from ITS-G5. In order to perform this measurement, LTE-V2X UEs are configured to recognize the ITS-G5 preamble, typically by correlations looking for the L-STF golden sequence.

Once the metric Tech_{percentage} has been determined, in this implementation, the number of time slots to assign to the second protocol (e.g., LTE-V2X) and the first protocol (e.g., ITS-G5) may be determined by table 1 below.

TABLE 1

| | Number of time slots | Number of time slots |
|---|---|---|
| Tech_{percentage} | granted to LTE-V2X | granted to ITS-G5 |
| 0% | 0 | 10 |
| (e.g., no LTE users) | | |
| <15% | 1 | 9 |
| [15-25[% | 2 | 8 |
| [25-35[% | 3 | 7 |
| [35-45[% | 4 | 6 |
| [45-55[% | 5 | 5 |
| [55-65[% | 6 | 4 |
| [65-75[% | 7 | 3 |
| [75-85]% | 8 | 2 |
| >85% | 9 | 1 |

where 25[means 25 non-inclusive and 85] means 85 inclusive. The above example is for illustration only, and in other implementations, the divisions of the superframes may be determined in other ways.

FIG. 5 illustrates a diagram 500 of time slots divided between two protocols and determining a pattern of time slots. FIG. 5 illustrates monitoring of a wireless channel by a UE corresponding to the first protocol, such as UE 115. The monitoring may be part of a process of determining a pattern of assignments of time slots, as described with reference to FIG. 3. For example, UE 115 may monitor the wireless channel for a time period X. During the time period X, UE 115 may try to detect a preamble according to the first protocol during each window Y. The window length may correspond to the length of a time slot. After collecting all the measurements for the total of time period X, UE 115 splits the measurements into chunks of sub-time period Z. As described with reference to FIG. 4, Z is the duration of a superframe and is programmed at UE 115.

To illustrate, FIG. 5 illustrates a first group of time slots 502. In a particular implementation, time slots that are shaded indicate time slots during which UE 115 detects a transmission in accordance with the first protocol (or that the wireless channel is empty) and time slots that are not shaded indicate time slots during which UE 115 detects a transmission in accordance with the second protocol. In a particular implementation illustrated in FIG. 5, Y corresponds to 1 ms, Z corresponds to 10 ms, and X corresponds to 20 ms. In other implementations, X, Y, and Z may have other values, for example X may be 100 ms. Additionally, in the particular implementation illustrated in FIG. 5, UE 115 begins monitoring the wireless channel during a time slot corresponding to time slot 6 of the pattern established by one of the UEs the corresponds to the second protocol (e.g., starting at a time slot 1). As can be appreciated, the pattern established by the other UEs may be offset from the pattern detected by UE 115, but the overall pattern will still be the same, just beginning at a different time slot.

After obtaining the measurements (e.g., by monitoring the wireless channel), UE 115 breaks the measurements down into chunks having the duration of time period Z. For example, UE 115 may break first group of time slots 502 into a first sub-group of time slots 504 and a second sub-group of time slots 506. Each of the sub-groups of time slots may include 10 time slots. The two sub-groups of time slots 504 and 506 may be combined by UE 115 to determine the pattern, indicated by third sub-group of time slots 508. For example, a logical AND operation may be performed with respect to time slots detected with transmissions according to the first protocol, or a logical OR operation may be performed with respect to time slots detected with transmissions according to the second protocol. Regardless of which operation is used, only “overlapping” time slots (e.g., time slots that correspond to the first protocol in all the sub-groups of time slots) are determined to be designated for transmissions according to the first protocol. To illustrate, UE 115 may determine, during the first sub-time period (corresponding to the first sub-group of time slots) a first one or more time slots during which UEs corresponding to the second protocol transmitted and, during the second sub-time period (corresponding to the second sub-group of time slots) a second one or more time slots during which the UEs transmitted. UE 115 may further determine one or more overlapping time slots between the first one or more time slots and the second one or more time slots to determine the pattern. For example, in first sub-group of time slots 504, time slots 8, 9, 10, 3, and 5 are detected as corresponding to the first protocol, and in second sub-group of time slots 506, time slots 8, 9, 10, and 4 are detected as corresponding to the first protocol. Because only time slots 8, 9, and 10 overlap (e.g., are detected as corresponding to the first protocol in both sub-groups of time slots), the determined pattern is that time slots 8, 9, and 10 are designated for communications in accordance with the first protocol, and time slots 1-7 are designated for communications in accordance with the second protocol. Although described as time slots 8, 9, and 10, to UE 115, time slots 8, 9, and 10 correspond to a third, fourth, and fifth time slot in the repeating pattern due to UE beginning to monitor at time slot 6. Although determining a pattern based on two sub-time periods has been described, in other implementations, a UE may partition a group of time slots into more than two sub-time periods, such as 100 or more sub-time periods, to determine the pattern.

Thus, FIG. 5 illustrates how a pattern of time slot assignments may be determined by monitoring a wireless channel for communications. By determining the pattern, UE 115 can determine a time to transmit a message (e.g., during a third, fourth, or fifth time slot during any 10 ms time period) without causing interference with UEs corresponding to the second protocol.

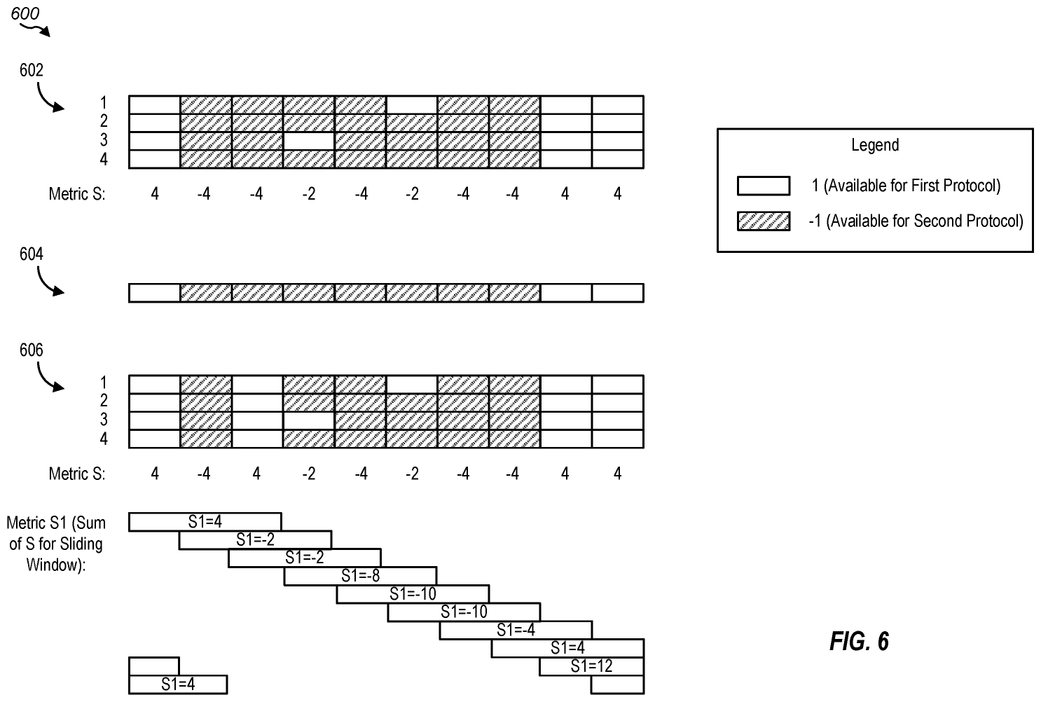

FIG. 6 illustrates a diagram 600 of signal detections used to determine a pattern of time slot assignments to multiple protocols. For example, a UE, such as UE 115, may monitor a wireless channel for communications from other UEs during one or more time periods to detect signals corresponding to the multiple protocols, and the timing of the detected signals may be used to determine the pattern based on an algorithm.

FIG. 6 includes a set of signal detections 602, a pattern 604, and a second set of signal detections 606. First set of signal detections 602 may correspond to multiple time periods (or sub-time periods) during which the UE monitors the wireless channel and detects communications by UEs corresponding to a first protocol or a second protocol. For example, the UE may detect a signal transmitted by a UE corresponding to the first protocol (or detect that the wireless channel remains empty) during a first time slot, and the UE may detect a signal transmitted by a UE corresponding to the second protocol during a second time slot.

In the example of FIG. 6, first set of signal detections 602 corresponds to four time periods of 10 time slots each. For example, each row of first set of signal detections 602 represents a time period (or sub-time period) that includes 10 time slots, and each column of first set of signal detections 602 represents signal detections during a particular time slot of each of the time periods.

To determine the pattern of time slot assignments, the UE may apply a first algorithm to first set of signal detections 602. In some implementations, the first algorithm may be a “base” algorithm based on a metric S. To determine the metric S, the UE may assign a value of 1 to each signal detection corresponding to the first protocol, and a value of −1 to each signal detection corresponding to the second protocol. S may be determined for each time slot by summing the corresponding values for each time period during the time slot. For example, S may be determined by summing the values corresponding to each column of first set of signal detections 602. To illustrate, S for the first time slot is 4 because each row in the first column has a value of 1, based on a signal detection corresponding to the first protocol during the first time slot of each of the four time periods. As another example, for the fourth time slot, 3 signal detections corresponding to the second protocol and one signal detection corresponding to the first protocol were detected by the UE, thus S is the sum of −1+−1+−1+1=−2. Once S is determined for each time slot, the UE may determine the pattern based on the following first algorithm:
if S>threshold--->slot available for transmission
if S<=threshold--->slot not available for transmission.

In some implementations, the threshold is zero. In other implementations, the threshold may be less than zero or greater than zero. Based on the values of S corresponding to first set of signal detections 602 shown in FIG. 6 and a threshold equal to zero, the UE may determine that the first time slot, the ninth time slot, and the tenth time slot are available for transmission via the first protocol, and that the second through eighth time slots are not available for transmission (e.g., are used for communications via the second protocol). Based on this determination, the UE may determine pattern 604, which indicates assignment (e.g., reservation) of time slots to the first protocol and the second protocol for a time period including 10 time slots. In such an example, a time partition assigned to the first protocol has a duration of 3 time slots, and a time partition assigned to the second protocol has a duration of 7 time slots.

A benefit of determining pattern 604 using the first algorithm is that a UE corresponding to the first protocol may determine pattern 604 without knowledge of the duration of the time partition assigned to the first protocol. For example, pattern 604 may be determined entirely based on signal detection performed by the UE. However, in some situations, the UE may determine an incorrect pattern if signals are not properly detected. For example, if signal detections corresponding to the third time slot result in a value of S that is greater than the threshold (e.g., due to incorrect signal detections), the UE may determine that the third time slot is available for transmission via the first protocol even though such a determination would result in a divided time partition being assigned to the first protocol. A divided time partition refers to a time partition having one or more portions separated from one or more other portions by a time partition assigned to a different protocol. In at least some implementations, a divided partition is not allowed.

Second set of signal detections 606 represents such a situation. For example, as shown in FIG. 6, the UE does not detect signals corresponding to the second protocol during the third time slot. However, this may be due to incorrect detection or missed transmissions by one or more UEs corresponding to the second protocol. Based on the S values corresponding to second set of signal detections 606, the UE will not determine pattern 604 using the first algorithm, which may result in signal collisions during the third time slot between communications via the first protocol and communications via the second protocol.

To improve reliability of the pattern determined by the UE, the UE may determine the pattern based on a second algorithm, also referred to as an “enhanced” algorithm. In such implementations, the UE knows a-priori the duration T1 of the time partition assigned to the first protocol. For example, the UE may be preprogrammed with the duration T1 or another device, such as another UE or a base station, may signal the duration T1 to the UE. To perform the second algorithm, the UE may apply a sliding window having length T1 to the metric S values determined for the time slots and generate a corresponding sum of the metric S, also referred to as metric S1, for each location of the sliding window. The UE may determine the time partition assigned to the protocol as matching the sliding window location corresponding to the largest value of S1.

To illustrate, in FIG. 6, a sliding window having a length of 3 time slots is applied to the metric S values determined based on second set of signal detections 606. A sum of the S values for a first location of the sliding window (e.g., the first time slot through the third time slot) is 4−4+4=4, a sum of the S values for a second location of the sliding window (e.g., the second time slot through the fourth time slot) is −4+4−2=−2, etc. As shown in FIG. 6, the location of the sliding window corresponding to the ninth time slot through the first time slot has the largest sum (e.g., 12). Thus, the UE determines that the time partition assigned to the first protocol is the ninth time slot through the first time slot, which corresponds to pattern 604. As described with reference to FIG. 6, determining the pattern based on the second algorithm may result in a more reliable pattern estimation. However, because the duration T1 is required by the UE to use the second algorithm, the second algorithm may only be used if the durations of time partitions are static or semi-static (e.g., not dynamic).

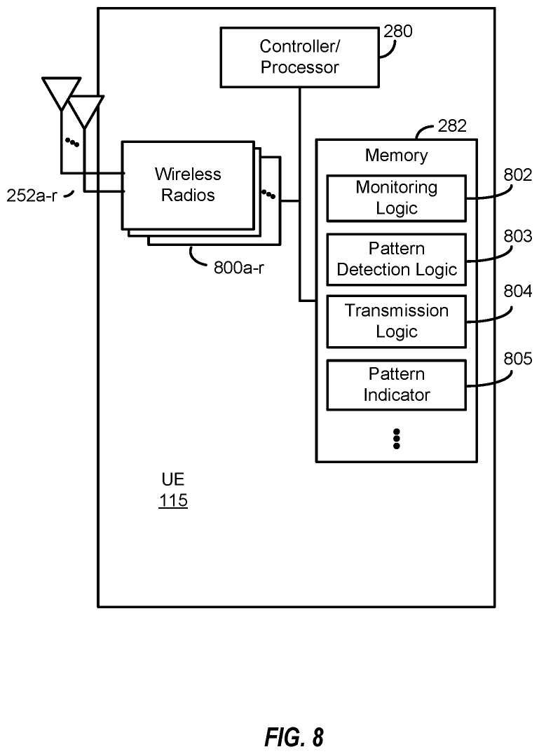

FIG. 7 is a block diagram illustrating example blocks executed to implement one aspect of the present disclosure. The example blocks will also be described with respect to UE 115 as illustrated in FIG. 8. FIG. 8 is a block diagram illustrating UE 115 configured according to one aspect of the present disclosure. UE 115 includes the structure, hardware, and components as illustrated for UE 115 of FIG. 2. For example, UE 115 includes controller/processor 280, which operates to execute logic or computer instructions stored in memory 282, as well as controlling the components of UE 115 that provide the features and functionality of UE 115. UE 115, under control of controller/processor 280, transmits and receives signals via wireless radios 800a-r and antennas 252a-r. Wireless radios 800a-r includes various components and hardware, as illustrated in FIG. 2 for UE 115, including modulator/demodulators 254a-r, MIMO detector 256, receive processor 258, transmit processor 264, and TX MIMO processor 266.

At block 700, a first UE corresponding to a first protocol detects one or more time slots during which a second UE corresponding to a second protocol is transmitting via a wireless channel. The first protocol is different from the second protocol. A UE, such as UE 115, may execute, under control of controller/processor 280, monitoring logic 802, stored in memory 282. The execution environment of monitoring logic 802 provides the functionality for UE 115 to monitor a wireless channel and to detect one or more time slots during which a second UE (corresponding to a second protocol) is transmitting.

At block 701, the first UE transmits a message via the wireless channel during at least one time slot and according to a pattern based on the detected one or more time slots. The pattern represents a set of time slots designated as unavailable based on use by one or more UEs corresponding to the second protocol. The UE (e.g., UE 115) may execute, under control of controller/processor 280, pattern detection logic 803, stored at memory 282. The execution environment of pattern detection logic 803 provides the functionality for UE 115 to determine the pattern based on the detected one or more time slots. For example, the pattern may be detected by combining groups of measurements of time slots and looking for overlapping time slots, as further described with reference to FIG. 5. After determining the pattern, UE 115 may store pattern indicator 805 that represents the pattern. Pattern indicator 805 may include or correspond to pattern indicator 306 of FIG. 3. For example, pattern indicator 805 may include a bitmap or a coded value, as non-limiting examples. Additionally, the UE (e.g., UE 115) may execute, under control of controller/processor 280, transmission logic 804, stored at memory 282. The execution environment of transmission logic 804 provides the functionality for UE 115 to transmit a message via wireless radios 800a-r and antennas 252a-r.

In some aspects, techniques for enabling automatic detection of a pattern of dynamic transmission boundaries may include additional aspects, such as any single aspect or any combination of aspects described below and/or in connection with one or more other processes or devices described elsewhere herein. In some aspects, enabling automatic detection of a pattern of dynamic transmission boundaries may include an apparatus that corresponds to a first protocol detecting one or more time slots during which a second UE corresponding to a second protocol is transmitting via a wireless channel. The first protocol is different from the second protocol. The apparatus may also transmit a message via the wireless channel during at least one time slot and according to a pattern based on the detected one or more time slots. The pattern represents a set of time slots designated as unavailable based on use by one or more UEs corresponding to the second protocol. In some implementations, the apparatus includes a wireless device, such as a UE. In some implementations, the apparatus may include at least one processor, and a memory coupled to the processor. The processor may be configured to perform operations described herein with respect to the wireless device. In some other implementations, the apparatus may include a non-transitory computer-readable medium having program code recorded thereon and the program code may be executable by a computer for causing the computer to perform operations described herein with reference to the wireless device. In some implementations, the apparatus may include one or more means configured to perform operations described herein. In the aspects described herein, a protocol may also be referred to as a wireless communication technology, or vice-versa.

In a first aspect, the apparatus is not synchronized with respect to the second UE.

In a second aspect, alone or in combination with the first aspect, the detected one or more time slots indicate transmission boundaries associated with the second protocol, and the pattern enables time synchronization at the apparatus with respect to the second UE.

In a third aspect, alone or in combination with one or more of the first through second aspects, the first protocol includes an ITS-G5 protocol, and the second protocol includes a LTE-V2X protocol.

In a fourth aspect, alone or in combination with one or more of the first through third aspects, the apparatus monitors the wireless channel for a time period to detect the one or more time slots.

In a fifth aspect, in combination with the fourth aspect, the message is transmitted after the time period.

In a sixth aspect, in combination with one or more of the fourth through fifth aspects, the apparatus determines the pattern by detecting, during each of multiple sub-time periods of the time period, a corresponding one or more time slots during which the second UE is transmitting.

In a seventh aspect, in combination with the sixth aspect, determining the pattern further includes determining one or more overlapping time slots between the corresponding one or more time slots associated with the multiple sub-time periods. The pattern is defined by the one or more overlapping time slots.

In an eighth aspect, in combination with the sixth aspect, the apparatus accesses a duration of a time partition assigned to the first protocol from a memory or receives the duration of the time partition from another device. Determining the pattern further includes applying a sliding window to detections during each of the multiple time periods. The sliding window has a length equal to the duration of the time partition.

In a ninth aspect, alone or in combination with one or more of the first through eighth aspects, the apparatus detects at least one time slot during which a third UE corresponding to the first protocol is transmitting or the wireless channel is available. The pattern is further based on the at least one time slot.

In a tenth aspect, in combination with the ninth aspect, detecting that the third UE is transmitting includes identifying a particular preamble in a message transmitted by the third UE.

In an eleventh aspect, in combination with the tenth aspect, detecting that the second UE is transmitting comprises detecting an amount of energy on the wireless channel that satisfies a threshold without detecting the particular preamble.

In a twelfth aspect, alone or in combination with one or more of the first through eleventh aspects, a wireless communication system that includes the apparatus, the second UE, and the one or more UEs is configured to implement a time division multiplexing (TDM) system without UEs corresponding to different protocols being synchronized with respect to each other.

In a thirteenth aspect, in combination with the twelfth aspect, the TDM system defines a time partition between the first protocol and the second protocol. The time partition is static, semi-static, or dynamic.

In a fourteenth aspect, alone or in combination with one or more of the first through thirteenth aspects, the pattern further represents a second set of time slots designated as available for UEs corresponding to the first protocol.

In a fifteenth aspect, alone or in combination with one or more of the first through fourteenth aspects, the one or more UEs establish the pattern.

In a sixteenth aspect, in combination with the fifteenth aspect, the one or more UEs establish the pattern based on a metric based on a channel busy ratio.

In a seventeenth aspect, alone or in combination with one or more of the first through sixteenth aspects, the apparatus stores a pattern indicator that represents the pattern at a memory.

In an eighteenth aspect, in combination with the seventeenth aspect, the pattern indicator includes a bitmap or a coded value.

In a nineteenth aspect, alone or in combination with one or more of the first through eighteenth aspects, the apparatus is configured to operate in accordance with the first protocol, and the second UE corresponding to the second protocol is configured to operate in accordance with the second protocol.

In a twentieth aspect, alone or in combination with one or more of the first through nineteenth aspects, the apparatus comprises a first component of a first vehicle, and the second UE comprises a second component of a second vehicle.

In a twenty-first aspect, alone or in combination with one or more of the first through twentieth aspects, the pattern is cyclical over a particular time period.

In a twenty-second aspect, in combination with the twenty-first aspect, the particular time period corresponds to a duration of a superframe that is repeated after expiration of the particular time period.

In a twenty-third aspect, in combination with the twenty-second aspect, the duration of the superframe is preprogrammed at the apparatus or received by the apparatus from another device.

In a twenty-fourth aspect, alone or in combination with one or more of the first through twenty-third aspects, the set of time slots are adjacent time slots within a time period.

In a twenty-fifth aspect, alone or in combination with one or more of the first through twenty-fourth aspects, the wireless channel corresponds to a 5.9 gigahertz (GHz) band.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The functional blocks and modules described herein (e.g., the functional blocks and modules in FIG. 2) may comprise processors, electronics devices, hardware devices, electronics components, logical circuits, memories, software codes, firmware codes, etc., or any combination thereof.

Those of skill would further appreciate that the various illustrative logical blocks, modules, circuits, and algorithm steps (e.g., the logical blocks in FIG. 7) described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. Computer-readable storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, a connection may be properly termed a computer-readable medium. For example, if the software is transmitted from a website, server, or other remote source using a coaxial cable, fiber optic cable, twisted pair, or digital subscriber line (DSL), then the coaxial cable, fiber optic cable, twisted pair, or DSL, are included in the definition of medium. Disk and disc, as used herein, includes compact disc (CD), laser disc, optical disc, digital versatile disc (DVD), hard disk, solid state disk, and blu-ray disc where disks usually reproduce data magnetically, while discs reproduce data optically with lasers. Combinations of the above should also be included within the scope of computer-readable media.

As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C) or any of these in any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

1. A method of wireless communication, the method comprising:
detecting, at a first user equipment (UE) corresponding to a first protocol, one or more time slots during which a second UE corresponding to a second protocol is transmitting via a wireless channel, the first protocol different from the second protocol; and
transmitting, by the first UE, a message via the wireless channel during at least one time slot and according to a pattern based on the detected one or more time slots, the pattern representing a set of time slots designated as unavailable based on use by one or more UEs corresponding to the second protocol.

2. The method of claim 1, wherein the first UE is not synchronized with respect to the second UE.

3. The method of claim 1, wherein the detected one or more time slots indicate transmission boundaries associated with the second protocol, and wherein the pattern enables time synchronization at the first UE with respect to the second UE.

4. The method of claim 1, wherein the first protocol comprises an ITS-G5 protocol, and wherein the second protocol comprises a LTE-V2X protocol.

5. The method of claim 1, further comprising monitoring, by the first UE, the wireless channel for a time period to detect the one or more time slots.

6. The method of claim 5, wherein the message is transmitted after the time period.

7. The method of claim 5, further comprising determining, by the first UE, the pattern by detecting, during each of multiple sub-time periods of the time period, a corresponding one or more time slots during which the second UE is transmitting.

8. The method of claim 7, wherein determining the pattern further comprises determining one or more overlapping time slots between the corresponding one or more time slots associated with the multiple sub-time periods, and wherein the pattern is defined by the one or more overlapping time slots.

9. The method of claim 7, further comprising accessing a duration of a time partition assigned to the first protocol from a memory or receiving the duration of the time partition from another device, wherein determining the pattern further comprises applying a sliding window to detections during each of the multiple sub-time periods, the sliding window having a length equal to the duration of the time partition.

10. The method of claim 1, further comprising detecting, by the first UE, at least one time slot during which a third UE corresponding to the first protocol is transmitting or the wireless channel is available, wherein the pattern is further based on the at least one time slot.

11. The method of claim 10, wherein detecting that the third UE is transmitting includes identifying a particular preamble in a message transmitted by the third UE.

12. The method of claim 11, wherein detecting that the second UE is transmitting comprises detecting an amount of energy on the wireless channel that satisfies a threshold without detecting the particular preamble.

13. An apparatus configured for wireless communication, the apparatus comprising:
at least one processor; and
a memory coupled to the at least one processor, the memory storing instructions that, when executed by the at least one processor, cause the at least one processor to:
detect, at a first user equipment (UE) corresponding to a first wireless communication technology, one or more time slots during which a second UE corresponding to a second wireless communication technology is transmitting via a wireless channel, the first wireless communication technology different from the second wireless communication technology; and
initiate transmission of a message via the wireless channel during at least one time slot and according to a pattern based on the detected one or more time slots, the pattern representing a set of time slots designated as unavailable based on use by one or more UEs corresponding to the second wireless communication technology.

14. The apparatus of claim 13, wherein a wireless communication system that includes the first UE, the second UE, and the one or more UEs is configured to implement a time division multiplexing (TDM) system without UEs corresponding to different wireless communication technologies being synchronized with respect to each other.

15. The apparatus of claim 14, wherein the TDM system defines a time partition between the first wireless communication technology and the second wireless communication technology, and wherein the time partition is static, semi-static, or dynamic.

16. The apparatus of claim 13, wherein the pattern further represents a second set of time slots designated as available for UEs corresponding to the first wireless communication technology.

17. The apparatus of claim 13, wherein the one or more UEs establish the pattern.

18. The apparatus of claim 17, wherein the one or more UEs establish the pattern based on a metric based on a channel busy ratio.

19. The apparatus of claim 13, wherein the instructions, when executed by the at least one processor, further cause the at least one processor to store a pattern indicator that represents the pattern at the memory.

20. The apparatus of claim 19, wherein the pattern indicator comprises a bitmap or a coded value.

21. The apparatus of claim 13, wherein the first UE corresponding to the first wireless communication technology is configured to operate in accordance with the first wireless communication technology, and wherein the second UE corresponding to the second wireless communication technology is configured to operate in accordance with the second wireless communication technology.

22. The apparatus of claim 13, wherein the first UE comprises a first component of a first vehicle, and wherein the second UE comprises a second component of a second vehicle.

23. An apparatus configured for wireless communication, the apparatus comprising:
means for detecting, at a first user equipment (UE) corresponding to a first protocol, one or more time slots during which a second UE corresponding to a second protocol is transmitting via a wireless channel, the first protocol different from the second protocol; and
means for transmitting a message via the wireless channel during at least one time slot and according to a pattern based on the detected one or more time slots, the pattern representing a set of time slots designated as unavailable based on use by one or more UEs corresponding to the second protocol.

24. The apparatus of claim 23, wherein the pattern is cyclical over a particular time period.

25. The apparatus of claim 24, wherein the particular time period corresponds to a duration of a superframe that is repeated after expiration of the particular time period.

26. The apparatus of claim 25, wherein the duration of the superframe is preprogrammed at the first UE or received by the first UE from another device.

27. The apparatus of claim 23, further comprising means for monitoring the wireless channel for a time period to detect the one or more time slots, wherein the message is transmitted after the time period.

28. A non-transitory computer-readable medium storing instructions that, when executed by a processor, cause the processor to perform operations comprising:
detecting, at a first user equipment (UE) corresponding to a first wireless communication technology, one or more time slots during which a second UE corresponding to a second wireless communication technology is transmitting via a wireless channel, the first wireless communication technology different from the second wireless communication technology; and
initiating transmission of a message via the wireless channel during at least one time slot and according to a pattern based on the detected one or more time slots, the pattern representing a set of time slots designated as unavailable based on use by one or more UEs corresponding to the second wireless communication technology.

29. The non-transitory computer-readable medium of claim 28, wherein the set of time slots are adjacent time slots within a time period.

30. The non-transitory computer-readable medium of claim 28, wherein the wireless channel corresponds to a 5.9 gigahertz (GHz) band.
